(19) United States
(12) Patent Application Publication
(10) Pub. No.: US 2014/0188572 A1
(43) Pub. Date: Jul. 3, 2014

(54) ANALYZING PERFORMANCE INDICATORS

(71) Applicants: Sumanth Hegde, Bangalore (IN); Dharshan A, Bangalore (IN); Tarun Shetty, Bangalore (IN)

(72) Inventors: Sumanth Hegde, Bangalore (IN); Dharshan A, Bangalore (IN); Tarun Shetty, Bangalore (IN)

(21) Appl. No.: 13/732,672

(22) Filed: Jan. 2, 2013

(51) Int. Cl. G06Q 10/06

(52) U.S. Cl. CPC G06Q 10/06393
USPC 705/7.39

(57) ABSTRACT

Techniques for performing a time period change analysis include identifying a performance indicator associated with a set of data, the performance indicator representing a statistical metric associated with the set of data; identifying one or more master data measures associated with the performance indicator from a plurality of master data measures, the performance indicator based on the one the master data measures; for each time period of a plurality of times periods, determining a value of the one or more master data measures; for each master data measure, determining a difference between the values of the master data measure associated with two time periods of the plurality of time period; and preparing the determined difference for display to a user through a graphical user interface.

### TECHNICAL BACKGROUND

This disclosure relates to analysis of performance indicators and, more particularly, time period change analysis of performance indicators.

### BACKGROUND

In some computing environments, there are multiple system types, for example, OnLine Transaction Processing (OLTP) and OnLine Analytical Processing (OLAP) systems. OLTP systems are used to carry out business processes that result in the creation of business documents. OLAP systems are implemented to analyze data and to facilitate decision-making In some examples, OLAP systems can include data warehousing and business intelligence (BI) tools, and further offer a modeling environment to create reports (e.g., visualization of reports).

One of the most common types of reporting is to analyze changes over a period of time. Normally fixed time periods (e.g., a year, a quarter, a month) are convenient means of comparisons for performance indicators which the user is interested in. Specifically, a user might be interested in the analysis of a performance indictor over a time period. For example, the analysis of the opportunity closing rate over a year or the analysis of the order fulfillment rate over four consecutive quarters.

### SUMMARY

The present disclosure relates to computer-implemented methods, software, and systems for performing a time period change analysis. In some implementations, a performance indicator associated with a set of data is identified. In some examples, the performance indicator represents a statistical metric associated with the set of data. Master data measures associated with the performance indicator are identified from multiple master data measures. In some examples, the performance indicator is based on the master data measures. For each time period of multiple times periods, a value of the master data measures is determined. For each master data measure, a difference is determined between the values of the master data measure associated with two time periods of the multiple of time periods. The determined difference is prepared for display to a user through a graphical user interface.

Other general implementations include corresponding computer systems, apparatus, and computer programs recorded on one or more computer storage devices, each configured to perform the actions of the methods. A system of one or more computers can be configured to perform operations to perform the actions. One or more computer programs can be configured to perform particular operations or actions by virtue of including instructions that, when executed by data processing apparatus, cause the apparatus to perform the actions.

A first aspect combinable with any of the general implementations includes defining the master data measures based on an additional set of data.

A second aspect combinable with any of the previous aspects includes associating one or more of the master data measures with one or more performance indicators of multiple performance indicators.

A third aspect combinable with any of the previous aspects includes, for each performance indictor of the performance indicators, identifying a rank associated with each of the master data measures; and ranking the master data measures that are associated with the performance indicator based on the rank associated with each of the master data measures.

A fourth aspect combinable with any of the previous aspects includes for each time period of the times periods, determining a value of the performance indictor.

A fifth aspect combinable with any of the previous aspects includes preparing the determined value for display to the user through the graphical user interface.

In a sixth aspect combinable with any of the previous aspects, the value of the performance indicator is based on the value of the data measures.

In a seventh aspect combinable with any of the previous aspects, the performance indicator is directly correlated to the master data measures.

In an eighth aspect combinable with any of the previous aspects, the difference between the values of the master data measures is greater than a threshold.

A ninth aspect combinable with any of the previous aspects includes receiving, from the user, a request for analysis of the set of data.

In a tenth aspect combinable with any of the previous aspects, identifying the performance indicator further includes identifying the performance indicator based on the request.

Various implementations of a computing system according to the present disclosure may have one or more of the following features. For example, a user could understand the relevant changes in the system between the time periods and thereby determine the causes for changes in the performance indicator values over the period in question.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example distributed computing system for performing a time period change analysis;

FIG. 2 illustrates an example environment of a distributed computing system operable to perform a time period change analysis;

FIG. 3 is a flow chart of an example method for performing a time period change analysis;

FIG. 4 illustrates an example graphical user interface that displays a performance indicator and master data measures; and

FIG. 5 is a flow chart of another example method for performing a time period change analysis.

### DETAILED DESCRIPTION

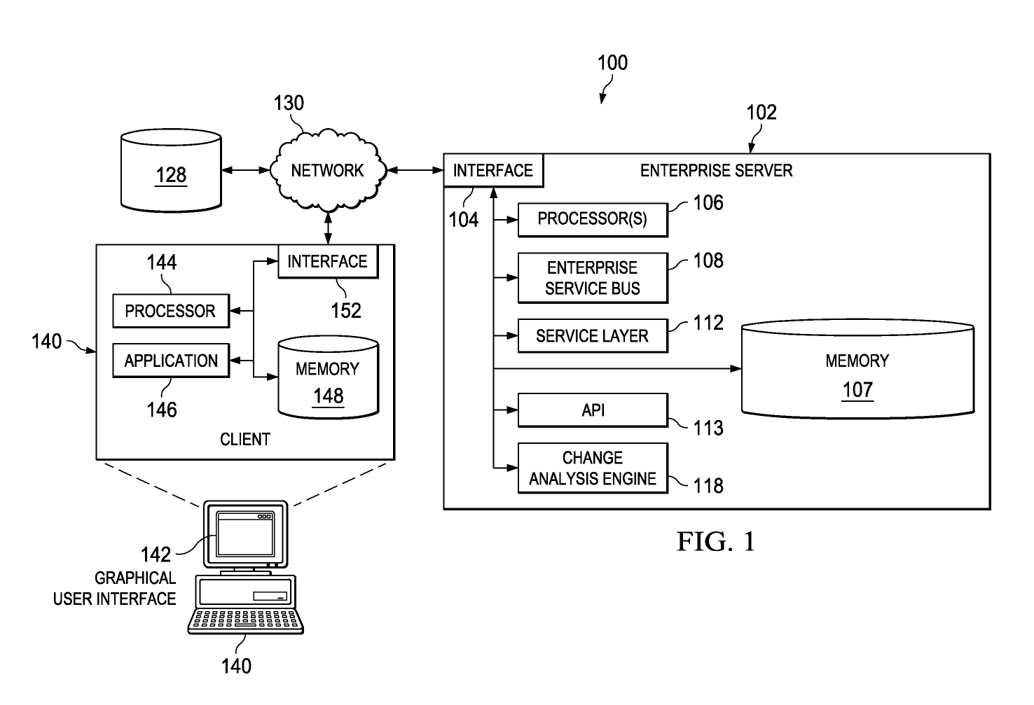

FIG. 1 illustrates an example distributed computing system 100 for performing a time period change analysis. For example, the illustrated distributed computing system 100 includes or is communicably coupled with an enterprise server computing system 102, a client computing system 140, and a repository 128, at least some of which communicate across a network 130. In general, the enterprise server computing system 102 is any server that stores one or more hosted applications, such as for example, a change analysis engine 118, where at least a portion of the hosted applications are executed via requests and responses sent to users or clients within and communicably coupled to the illustrated distributed computing system 100 of FIG. 1. In some aspects, computing system 100 performs a time period change analysis. In some implementations, performing the time period change analysis can include identifying a performance indicator that represents a statistical metric associated with a set of data. The performance indicator can be based on master data measures, which are identified. A value of the master data measures is determined for multiple time periods. For each master data measures, a difference is determined between the values of the master data measure associated with two time periods. The determined difference is prepared for display.

In some examples, the enterprise server computing system 102 may store a plurality of various hosted applications, while in some examples, the enterprise server computing system 102 may be a dedicated server meant to store and execute only a single hosted application. In some instances, the enterprise server computing system 102 may comprise a web server, where the hosted applications represent one or more web-based applications accessed and executed via the network 130 by the client computing system 140 to perform the programmed tasks or operations of the hosted application.

At a high level, the enterprise server computing system 102 comprises an electronic computing device operable to receive, transmit, process, store, or manage data and information associated with the distributed computing system 100. Specifically, the enterprise server computing system 102 illustrated in FIG. 1 is responsible for receiving application requests from one or more client applications associated with the client computing system 140 of the distributed computing system 100 and responding to the received requests by processing said requests in the associated hosted application, and sending the appropriate response from the hosted application back to the requesting client application. In addition to requests from the client computing system 140 illustrated in FIG. 1, requests associated with the hosted applications may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single enterprise server computing system 102, the distributed computing system 100 can be implemented using two or more servers, as well as computers other than servers, including a server pool. In some examples, the enterprise server computing system 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the enterprise server computing system 102 may be adapted to execute any operating system, including Linux, UNIX, Windows, Mac OS, or any other suitable operating system.

As mentioned above, the enterprise server computing system 102 includes a change analysis engine 118. In summary, the change analysis engine 118 identifies a particular performance indicator; for the particular performance indicator, identify one or more master data measures associated with the particular performance indicator; for each time period, determine a value of the associated master data measures; for each master data measure, determine a difference between the values associated with two time periods; and output the determined difference to the client computing device 140, described further below.

The enterprise server computing system 102 further includes an interface 104. Although illustrated as a single interface 104 in FIG. 1, two or more interfaces 104 may be used according to particular needs, desires, or particular implementations of the example distributed computing system 100. The interface 104 is used by the enterprise server computing system 102 for communicating with other systems in a distributed environment—including within the example distributed computing system 100—connected to the network 130; for example, the client computing system 140 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

Regardless of the particular implementation, “software” may include computer-readable instructions, firmware, wired or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, assembler, Perl, any suitable version of 4GL, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The enterprise server computing system 102 further includes a processor 106. Although illustrated as a single processor 106 in FIG. 1, two or more processors may be used according to particular needs, desires, or particular implementations of the example distributed computing system 100. The processor 106 may be a central processing unit (CPU), a blade, an application specific integrated circuit (ASIC), a field-programmable gate array (FPGA), or another suitable component. Generally, the processor 106 executes instructions and manipulates data to perform the operations of the enterprise server computing system 102. Specifically, the processor 106 executes the functionality required to receive and respond to requests from the client computing system 140.

The enterprise server computing system 102 also includes a memory 107. Although illustrated as a single memory 107 in FIG. 1, two or more memories may be used according to particular needs, desires, or particular implementations of the example distributed computing system 100. While memory 107 is illustrated as an integral component of the enterprise server computing system 102, in some implementations, the memory 107 can be external to the enterprise server computing system 102 and/or the example distributed computing system 100. The memory 107 may include any memory or database module and may take the form of volatile or non-volatile memory including, without limitation, magnetic media, optical media, random access memory (RAM), read-only memory (ROM), removable media, or any other suitable local or remote memory component. The memory 107 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the enterprise computing system 102. Additionally, the memory 107 may include any other appropriate data, such as VPN applications, firmware logs and policies, firewall policies, a security or access log, print or other reporting files, as well as others.

The enterprise server computing system 102 further includes a service layer 112. The service layer 112 provides software services to the example distributed computing system 100. The functionality of the enterprise server computing system 102 may be accessible for all service consumers using this service layer. For example, in one implementation, the client computing system 140 can utilize the service layer 112 to communicate with the change analysis engine 118. Software services provide reusable, defined business functionalities through a defined interface. For example, the interface may be software written in extensible markup language (XML) or other suitable language. While illustrated as an integrated component of the enterprise server computing system 102 in the example distributed computing system 100, alternative implementations may illustrate the service layer 112 as a stand-alone component in relation to other components of the example distributed computing system 100. Moreover, any or all parts of the service layer 112 may be implemented as child or sub-modules of another software module, enterprise application, or hardware module without departing from the scope of this disclosure.

The enterprise server computing system 102 further includes an application programming interface (API) 113. In some implementations, the API 113 can be used to interface between the change analysis engine 118 and one or more components of the enterprise server computing system 102 or other components of the example distributed computing system 100, both hardware and software. For example, in some implementations, the change analysis engine 118 can utilize the API 113 to communicate with the client computing system 140. The API 113 may include specifications for routines, data structures, and object classes. The API 113 may be either computer language independent or dependent and refer to a complete interface, a single function, or even a set of APIs. While illustrated as an integrated component of the enterprise server computing system 102 in the example distributed computing system 100, alternative implementations may illustrate the API 113 as a stand-alone component in relation to other components of the example distributed computing system 100. Moreover, any or all parts of the API 113 may be implemented as child or sub-modules of another software module, enterprise application, or hardware module without departing from the scope of this disclosure.

The client computing system 140 may be any computing device operable to connect to or communicate with at least the enterprise server computing system 102 using the network 130. In general, the client computing system 140 comprises a computer operable to receive, transmit, process, and store any appropriate data associated with the example distributed computing system 100. The illustrated client computing system 140 further includes an application 146. The application 146 is any type of application that allows the client computing system 140 to request and view content on the client computing system 140. In some implementations, the application 146 can be and/or include a web browser. In some implementations, the application 146 can use parameters, metadata, and other information received at launch to access a particular set of data from the enterprise server computing system 102. Once a particular application 146 is launched, a user may interactively process a task, event, or other information associated with the enterprise server computing system 102. Further, although illustrated as a single application 146, the application 146 may be implemented as multiple applications in the client computing system 140.

The illustrated client computing system 140 further includes an interface 152, a processor 144, and a memory 148. The interface 152 is used by the client computing system 140 for communicating with other systems in a distributed environment—including within the example distributed computing system 100—connected to the network 130; for example, the enterprise server computing system 102 as well as other systems communicably coupled to the network 130 (not illustrated). The interface 152 may also be consistent with the above-described interface 104 of the enterprise server computing system 102 or other interfaces within the example distributed computing system 100. The processor 144 may be consistent with the above-described processor 106 of the enterprise server computing system 102 or other processors within the example distributed computing system 100. Specifically, the processor 144 executes instructions and manipulates data to perform the operations of the client computing system 140, including the functionality required to send requests to the enterprise server computing system 102 and to receive and process responses from the enterprise server computing system 102. The memory 148 may be consistent with the above-described memory 107 of the enterprise server computing system 102 or other memories within the example distributed computing system 100 but storing objects and/or data associated with the purposes of the client computing system 140.

Further, the illustrated client computing system 140 includes a GUI 142. The GUI 142 interfaces with at least a portion of the example distributed computing system 100 for any suitable purpose, including generating a visual representation of a web browser. In particular, the GUI 142 may be used to view and navigate various web pages located both internally and externally to the enterprise server computing system 102. Generally, through the GUI 142, an enterprise server computing system 102 user is provided with an efficient and user-friendly presentation of data provided by or communicated within the example distributed computing system 100.

There may be any number of client computing systems 140 associated with, or external to, the example distributed computing system 100. For example, while the illustrated example distributed computing system 100 includes one client computing system 140 communicably coupled to the enterprise server computing system 102 using network 130, alternative implementations of the example distributed computing system 100 may include any number of client computing systems 140 suitable for the purposes of the example distributed computing system 100. Additionally, there may also be one or more client computing systems 140 external to the illustrated portion of the example distributed computing system 100 that are capable of interacting with the example distributed computing system 100 using the network 130. Moreover, while the client computing system 140 is described in terms of being used by a single user, this disclosure contemplates that many users may use one computer, or that one user may use multiple computers.

The illustrated client computing system 140 is intended to encompass any computing device such as a desktop computer, laptop/notebook computer, wireless data port, smart phone, personal data assistant (PDA), tablet computing device, one or more processors within these devices, or any other suitable processing device. For example, the client computing system 140 may comprise a computer that includes an input device, such as a keypad, touch screen, or other device that can accept user information, and an output device that conveys information associated with the operation of the enterprise server computing system 102 or the client computing system 140 itself, including digital data, visual information, or a GUI 142, as shown with respect to the client computing system 140.

The distributed computing system 100 further includes a repository 128. In some implementations, the repository 128 is an in-memory repository. The repository 128 can be a cloud-based storage medium. For example, the repository 128 can be networked online storage where data is stored on virtualized pools of storage.

With respect to the network 130, generally, the network 130 facilitates wireless or wireline communications between the components of the distributed computing system 100 (i.e., between the computing systems 102 and 140), as well as with any other local or remote computer, such as additional clients, servers, or other devices communicably coupled to network 130 but not illustrated in FIG. 1. The network 130 is illustrated as a single network in FIG. 1, but may be a continuous or discontinuous network without departing from the scope of this disclosure, so long as at least a portion of the network 130 may facilitate communications between senders and recipients. The network 130 may be all or a portion of an enterprise or secured network, while in another instance at least a portion of the network 130 may represent a connection to the Internet.

In some instances, a portion of the network 130 may be a virtual private network (VPN), such as, for example, the connection between the client computing system 140 and the enterprise server computing system 102. Further, all or a portion of the network 130 can comprise either a wireline or wireless link. Example wireless links may include 802.11a/b/g/n, 802.20, WiMax, and/or any other appropriate wireless link. In other words, the network 130 encompasses any internal or external network, networks, sub-network, or combination thereof operable to facilitate communications between various computing components inside and outside the illustrated distributed computing system 100. The network 130 may communicate, for example, Internet Protocol (IP) packets, Frame Relay frames, Asynchronous Transfer Mode (ATM) cells, voice, video, data, and other suitable information between network addresses. The network 130 may also include one or more local area networks (LANs), radio access networks (RANs), metropolitan area networks (MANs), wide area networks (WANs), all or a portion of the Internet, and/or any other communication system or systems at one or more locations.

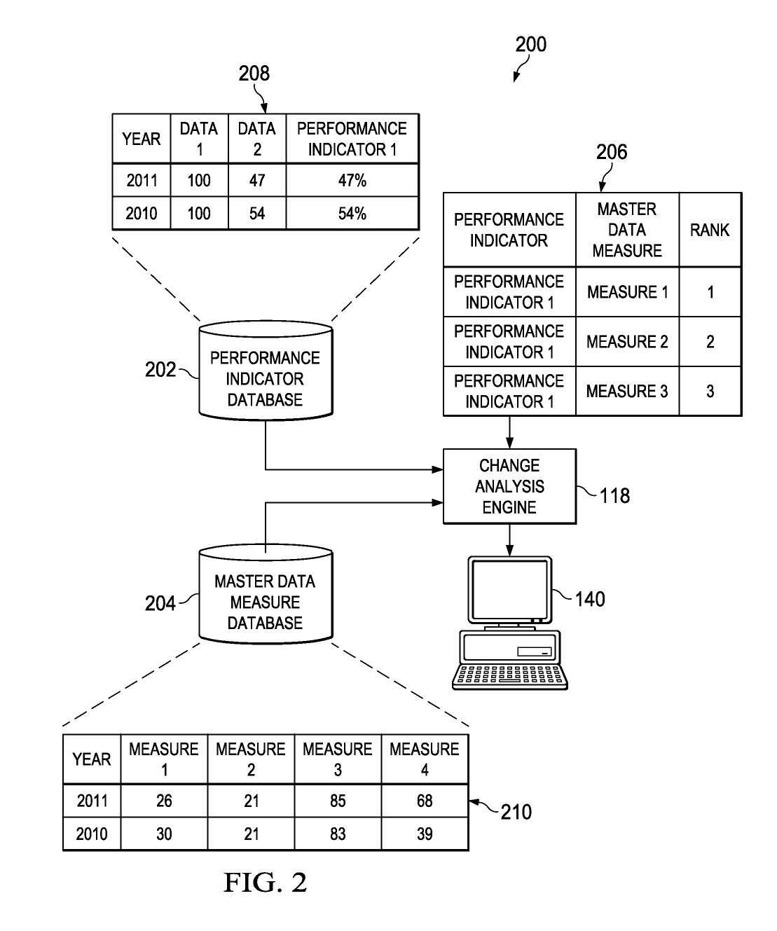

FIG. 2 illustrates an example environment 200 of a distributed computing system operable to perform a time period change analysis. The environment 200 includes the change analysis engine 118, a performance indicator database 202, a master data measures database 204, and an association table 206.

The performance indicator database 202 provides information to the change analysis engine 118 in the form of the performance indicator data log 208. The performance indicator data log 208 includes data that is associated with one or more performance indicators. Specifically, a performance indicator may represent a statistical metric associated with a set of data, and particularly, a statistical metric associated with the set of data over one or more time periods (e.g., a month, a quarter, a year). In some examples, the performance indicator is based on the set of data. For example, the “performance indicator 1” is based on “data 1” and “data 2,” as shown in FIG. 2. In some examples, the performance indicator can be based on one or more items of data. In some examples, one or more of the items of data can be associated with one or more performance indicators. In some examples, the performance indicator database 202 is stored in a repository.

In a particular example, the performance indicator is an opportunity cost indicator that is associated with (e.g., based on) a set of data. For example, the opportunity cost indicator is an indicator representing a ratio of a number of orders shipped to a number of orders received. The performance indicator 1 (e.g., the opportunity cost indicator) represents a ratio of the data 1 and the data 2 (e.g., a ratio of the number of order shipped to the number of orders received). Continuing, for a first time period (e.g., the year 2011), the performance indicator 1 has a value of 47%, that is, a ratio of data 2 (e.g., 47) to data 1 (e.g., 100) for the first time period (e.g., the year 2011); for a second time period (e.g., the year 2010), the performance indicator 1 has a value of 54%, that is, a ratio of data 2 (e.g., 54) to data 1 (e.g., 100) for the second time period (e.g., the year 2010).

Thus, in the instant example, the performance indicator 1 indicates a decrease in value from the second time period (e.g., the year 2010) to the first time period (e.g., the year 2011). Specifically, the performance indicator 1 indicates a decrease from 54% for the second time period to 47% for the first time period, that is, a decrease of 6%. To that end, one or more related factors can be determined that are related to the values of the performance indicators. For example, one or more related factors can be determined that are associated with the decrease in the value of the performance indicator 1 from the second time period to the first time period, described further below.

The master data measures database 204 provides information to the change analysis engine 118 in the form of a master data measure data log 210. The master data measure log 210 includes data that is associated with one or more master data measures. Specifically, the performance indicators (e.g., the performance indicator 1) may be based on one or more master data measures. In other words, the master data measures are factors that can affect associated performance indicators, and specifically, the values of the master data measures can affect an associated performance indicator. The master data measures are associated with (e.g., based on) a set of data over one or more time periods (e.g., a month, a quarter, a year). In some examples, the master data measures are associated with at least a portion of the data that the performance indicators are based on. In some examples, the master data measures are associated with differing data (e.g., an additional set of data) relative to those on which the performance indicators are based on. In some examples, the master data measures database 204 is stored in the same or differing repository as the performance indicator database 202.

In a particular example, the master data measures of the master data measures database 204 are associated with the opportunity cost indicator, mentioned above. For example, the master measure 1 can represent a number of sales team employees (for each respective time period); the master data measure 2 can represent a number of distribution centers (for each respective time period); the master data measure 3 can represent a number of new customers (for each respective time period); and the master data measure 4 can represent a number of shipping employees (for each time period). Continuing, for a first time period (e.g., the year 2011), the master data measure 1 has a value of 26, the master data measure 2 has a value of 21, the master data measure 3 has a value of 85, and the master data measure 4 has a value of 68. For a second time period (e.g., the year 2010), the master data measure 1 has a value of 30, the master data measure 2 has a value of 21, the master data measure 3 has a value of 83, and the master data measure 4 has a value of 39.

Thus, in the instant example, the master data measure 1 has a decrease in value from the second time period (e.g., the year 2010) to the first time period (e.g., the year 2011) of 4 sales team employees; the master data measure 2 remains constants from the second time period (e.g., the year 2010) to the first time period (e.g., the year 2011); the master data measure 3 has an increase in value from the second time period (e.g., the year 2010) to the first time period (e.g., the year 2011) of 2 distribution centers; and the master data measure 4 has an increase in value from the second time period (e.g., the year 2010) to the first time period (e.g., the year 2011) of 29 shipping employees. To that end, one or more of the master data measures 1, 2, 3, and 4 can be associated with the performance indicator 1 and the performance indicator 1 can be based on the one or more of the master data measures 1, 2, 3, and 4, described further below.

The association table 206 provides information to the change analysis engine 118 representing associations between the performance indicators (of the performance indicator data log 208) and the master data measures (of the master data measure log 210). Specifically, the association table 206 may include, for each performance indicator, the one or more master data measures that the performance indicator is based on. For example, the one or more master data measures are factors that affect the associated performance indicator. In some examples, the association of the master data measures to the performance indicators are predefined (e.g., by a user of the computing system 100, and particularly, the client computing system 140). In some examples, the association of the master data measures to the performance indicators is defined at design-time (e.g., prior to performing the time period change analysis). In some examples, a performance indicator can be associated with one or more master data measures. In some examples, a master data measure can be associated with one or more performance indicators.

In a particular example, the association table 206 indicates that the performance indicator 1 is associated with master data measures 1, 2 and 3. Thus, the opportunity cost indicator (e.g., the performance indicator 1) is associated with the number of sales team employees (e.g., master data measure 1), the number of distribution centers (e.g., master data measure 2), and the number of new customers (e.g., master data measure 3). In other words, the values of the number of sales team employees (e.g., master data measure 1), the number of distribution centers (e.g., master data measure 2), and the number of new customers (e.g., master data measure 3) are factors that affect the value of the opportunity cost indicator (e.g., the performance indicator 1), described further below.

In some further implementations, for each performance indicator, the one or more associated master data measures are ranked. Specifically, for each of the performance indicators, each of the associated master data measures can be associated with a rank (e.g., a numerical rank). In some examples, the rank of the master data measures is specific for each performance indicator that it is associated with. In some examples, the rank of the master data measures, for each performance indicator, is based on the performance indicator. The master data measures are ranked, for each performance indicator, based on the ranking for the performance indicator. In some examples, the ranks associated with the master data measures for each performance indicator are predefined (e.g., by a user of the computing system 100, and particularly, the client computing system 140). In some examples, the ranks associated with the master data measures for each performance indicator are defined at design-time (e.g., prior to performing the time period change analysis).

In a particular example, the association table 206 indicates the rank of the master data measures 1, 2, and 3 with respect to the performance indicator. Specifically, the association table 206 indicates that for the opportunity cost indicator (e.g., the performance indicator 1), the number of sales team employees (e.g., master data measure 1) is ranked first, the number of distribution centers (e.g., master data measure 2) is ranked third, and the number of new customers (e.g., master data measure 3) is ranked third.

The change analysis engine 118 receives the performance indicator data log 208 (and/or associated data), the master data measure data log 210 (and/or associated data), and the association table 210 (and/or associated data). The change analysis engine 118 processes the received data logs 208, 210 and the table 210 to identify a particular performance indicator; for the particular performance indicator, identify the one or more master data measures associated with the particular performance indicator; for each time period, determine a value of the associated master data measures; for each master data measure, determine a difference between the values associated with two time periods; and output the determined difference to the client computing device 140.

Specifically, the change analysis engine 118 may identify the particular performance indicator from the performance indicator data log 208. In some examples, the change analysis engine 118 can identify the particular performance indicator in response to user input (e.g., user selection of the particular performance indicator). For example, the change analysis engine 118 identifies the performance indicator 1 of the performance indicator data log 208 that is associated with data 1 and data 2.

The change analysis engine 118 identifies the master data measures associated with the particular performance indicator. Specifically, the change analysis engine 118 may identify the master data measures associated with the particular performance indicator from the association table 206. For example, for the performance indicator 1 (identified as the particular performance indicator), the change analysis engine 118 analyzes the association table 206 to identify that the master data measures 1, 2, and 3 as being associated with the performance indicator 1. Additionally, based on the analysis of the association table 206, the change analysis engine 118 can identify the rank associated with each of the master data measures. For example, for the performance indicator 1, the change analysis engine 118 analyzes the association table 206 to identify that the master data measures 1, 2, and 3 are ranked first, second, and third, respectively.

The change analysis engine 118 determines the value of the master data measures (that are associated with the particular performance indicator) for each time period of a plurality of time periods. For example, the change analysis engine 118 determines the value of the associated master data measures for the performance indicator 1 (identified as the particular performance indicator). Continuing, the change analysis engine 118 identifies the values of the master data measures 1, 2, and 3 for the time periods of 2010 and 2011. Thus, the values of the master data measure 1 for the time periods 2010 and 2011 is 30 and 26, respectively; the values of the master data measure 2 for both of the time periods 2010 and 2011 is 21; and the values of the master data measure 3 for the time periods 2010 and 2011 is 85 and 83, respectively.

The change analysis engine 118 determines a difference between the values of the master data measures associated with two time periods. For example, the change analysis engine 118 determines a difference between the values of the master data measures 1, 2, and 3 for the time periods 2010 and 2011. Thus, the change analysis engine 118 determines a decrease in value of 4 of the master data measure 1 from the time period 2010 to 2011; no change in value of the master data measure 2 from the time period 2010 to 2011; and an increase in value of 2 of the master data measure 3 from the time period 2010 to 2011.

The change analysis engine 118 prepares for output the determined difference for display to the user through a graphical user interface of the client computing device 140. For example, the change analysis engine 118 prepares for output the difference of the values of the master data measures 1, 2, 3, for the time periods 2010 and 2011. In some implementations, the change analysis engine 118 compares the difference of the values of the master data measures 1, 2, 3, for the time periods 2010 and 2011 to a threshold. Based upon the comparison, the change analysis engine 118 prepares for output the difference of the values of the master data measures 1, 2, 3, for the time periods 2010 and 2011. For example, the change analysis engine 118 prepares for output the difference of the values of the master data measures 1, 2, 3, for the time periods 2010 and 2011 greater than the threshold. For example, the threshold is zero, and the change analysis engine 118 prepares for output the difference of the values of the master data measures 1 and 3 for the time periods 2010 and 2011, as the values of the master data measures 1 and 3 are greater than zero. In some implementations, the change analysis engine 118 prepares for output the difference of the values of the master data measures 1, 2, 3, for the time periods 2010 and 2011 in a ranked order. In some implementations, the change analysis engine 118 further prepares for output the particular performance indicator. For example, the change analysis engine 118 prepares for output the performance indicator 1 for the time periods 2010 and 2011.

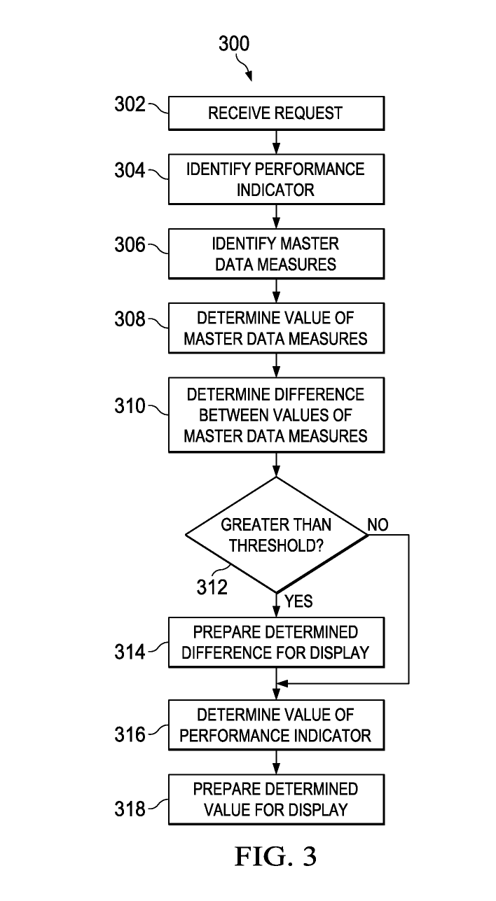

FIG. 3 is a flow chart that illustrates a method 300 for performing a time period change analysis. For clarity of presentation, the description that follows generally describes method 300 in the context of FIGS. 1 and 2. However, method 300 may be performed, for example, by any other suitable system, environment, software, and hardware, or a combination of systems, environments, software, and hardware as appropriate.

In step 302, a request, from a user, is received for analysis of a set of data. Specifically, the change analysis engine 118 may receive the request for the analysis of the performance indicator data log 208. For example, the change analysis engine 118 receives the request from a user of the client device 140. The analysis request of the performance indicator data log 208 can include a request of performance indicators of the performance indicator data log 208.

In step 304, a performance indicator is identified that is associated with the set of data. Further, the performance indicator represents a statistical metric associated with the set of data. Specifically, the change analysis engine 118 may identify the performance indictor that is associated with the set of data. For example, the change analysis engine 118 identifies the performance indicator 1 that is associated with the performance indicator data log 208, and specifically, associated with data 1 and data 2. The performance indicator 1 (e.g., the opportunity cost indicator) represents a ratio of the data 1 and the data 2 (e.g., a ratio of the number of order shipped to the number of orders received). In some implementations, the performance indicator is identified based on the received request (e.g., in step 302). Specifically, the request can include implicitly or explicitly a reference to the particular performance indicator that is identified.

In step 306, one or more master data measures are identified, from a plurality of master data measures that are associated with the performance indicator. Further, the performance indicator is based on the one or more master data measures. Specifically, the change analysis engine 118 may identify the one or more master data measures associated with the performance indicator from a plurality of master data measures. For example, the change analysis engine 118 identifies the master data measures associated with the particular performance indicator from the association table 206. For example, for the performance indicator 1, the change analysis engine 118 analyzes the association table 206 to identify that the master data measures 1, 2, and 3 as being associated with the performance indicator 1. The performance indicator (e.g., the performance indicator 1) is based on one or more master data measures (e.g., the master data measures 1, 2, and 3).

In some implementations, the performance indicator is directly correlated to the one or more master data measures. In some examples, the master data measures are factors that can affect the associated performance indicator, and specifically, the values of the master data measures can affect the performance indicator. Specifically, the value of the performance indicator (e.g., the performance indicator 1) may be based the values of the one or more master data measures (e.g., the master data measures 1, 2, and 3).

In step 308, for each time period of a plurality of time periods, a value of the one or more data measures is determined. Specifically, the change analysis engine 118 determines the value of the one or more data measures for each time period. For example, the change analysis engine 118 determines the value of the associated master data measures 1, 2, and 3 for the performance indicator 1 for the time periods of 2010 and 2011.

In step 310, for each of the master data measures, a difference is determined between the values of the master data measure associated with two time periods of the plurality of time periods. Specifically, the change analysis engine 118 may determine the difference, for each master data measure, between the values of the master data measures associated with two time periods. For example, the change analysis engine 118 determines a difference between the values of the master data measures 1, 2, and 3 for the time periods 2010 and 2011. In some examples, the time periods are consecutive time periods (e.g., consecutive quarters, or years). In some examples, the time periods are non-consecutive time periods (e.g., same quarters of differing years).

In step 312, it is determined whether the difference between the values of the one or more data measures is greater than a threshold. Specifically, the change analysis engine 118 may determine whether the difference between the values is greater than the threshold. For example, the change analysis engine 118 determines whether the difference between the values of the master data measures 1, 2, 3, for the time periods 2010 and 2011 greater than the threshold. In the instant examples, the change analysis engine 118 determines that the values of the master data measures 1 and 3 for the time periods 2010 and 2011 is greater than the threshold (e.g., zero). In some implementations, step 312 is optional.

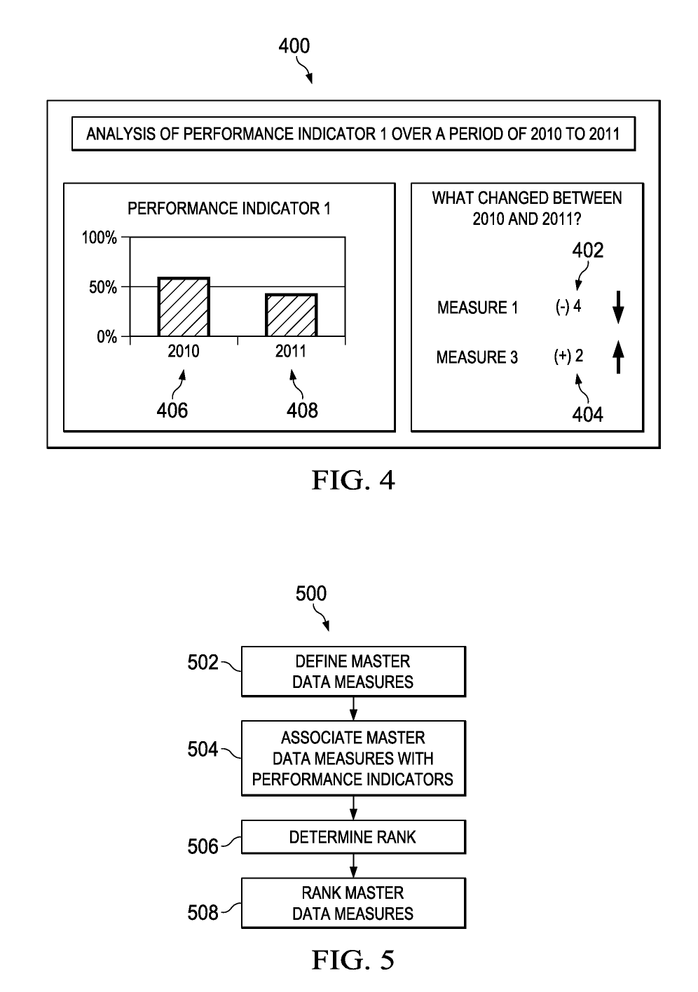

In step 314, if it is determined the difference between the values of the one or more master data measures is greater than the threshold, the determined difference is prepared for display to a user through a graphical user interface. Specifically, the change analysis engine 118 may prepare for display the determined difference for display through the graphical user interface. For example, FIG. 4 illustrates a graphical user interface 402 for display on the client computing device 140. The graphical user interface 402 includes the determined differences 402 and 404 representing the differences of the master data measures 1 and 3 (e.g., negative 4 and positive 2, respectively) for the time periods 2010 and 2011.

In step 316, for each time period of the plurality of time periods, a value of the performance indicator is determined. Specifically, the change analysis engine 118 may determine the value of the performance indicator. For example, the change analysis engine 118 determines the value of the performance indicator 1 for each of the time periods 2010 and 2011. In some implementations, the value of the performance indicator is based on the value of the one or more master data measures. For example, the value of the performance indicator 1 is based on the value of the master data measures 1, 2, and 3.

In step 318, the determined value (of the performance indicator) is prepared for display to the user through the graphical user interface. Specifically, the change analysis engine 118 may prepare for display the determined value for display through the graphical user interface. For example, the graphical user interface of FIG. 4 includes the determined values 406 and 408 representing the values of the performance indicator 1 for the time periods 2010 and 2011, respectively

If it is determined that the difference between the values of the one or more master data measures is not greater than the threshold, the value of the performance indicator is determined for each time period of the plurality of time periods (in step 316).

FIG. 5 is a flow chart that describes an example method 500 for performing a time period change analysis. For clarity of presentation, the description that follows generally describes method 500 in the context of FIGS. 1 and 2. However, method 500 may be performed, for example, by any other suitable system, environment, software, and hardware, or a combination of systems, environments, software, and hardware as appropriate.

In step 502, the plurality of master data measures are defined (e.g. generated) based on an additional set of data. Specifically, the master data measure database 204 may include the master data measure data log 210. The master data measure data log 210 includes data that is associated with the master data measures. The master data measures are based on an additional set of data (e.g., a differing set of data than the set of data the performance indicators are based on). For example, the master data measure data log 210 can include master data measures 1, 2, and 3 based on an addition set of data.

In step 504, one or more of the plurality of master data measures are associated with one or more performance indicators of a plurality of performance indicators. Specifically, the association table 206 may include associations between the performance indicators (of the performance indicator data log 208) and the master data measures (of the master data measure log 210). The association table 206 includes, for each performance indicator, the one or more master data measures that are associated with the performance indicator. For example, the association table 206 indicates that the performance indicator 1 is associated with master data measures 1, 2 and 3.

In step 506, a rank is identified that is associated with each of the master data measures. Specifically, the association table 206 may include ranks of the master data measures with respect to each of the performance indicators. For example, the association table 206 indicates the ranks of the master data measures 1, 2, and 3 with respect to the performance indicator 1.

In step 508, the master data measures that are associated with the performance indicator are ranked based on the rank associated with each of the master data measures. Specifically, the change analysis engine 118 may rank the master data measures that are associated with each performance indicator. For example, per the association table 206, for the performance indicator 1, the master data measure 1 is ranked first, master data measure 2 is ranked second, and the master data measure 3 is ranked third.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order (e.g., FIGS. 3 and 5), this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method of performing a time period change analysis, the method comprising:
identifying a performance indicator associated with a set of data, the performance indicator representing a statistical metric associated with the set of data;
identifying one or more master data measures associated with the performance indicator from a plurality of master data measures, the performance indicator based on the one the master data measures;
for each time period of a plurality of times periods, determining a value of the one or more master data measures;
for each master data measure, determining a difference between the values of the master data measure associated with two time periods of the plurality of time period; and
preparing the determined difference for display to a user through a graphical user interface.

2. The method of claim 1, further comprising:
defining the plurality of master data measures based on an additional set of data; and
associating one or more of the plurality of master data measures with one or more performance indicators of a plurality of performance indicators.

3. The method of claim 2, further comprising, for each performance indictor of the plurality of performance indicators:
identifying a rank associated with each of the master data measures; and
ranking the plurality of master data measures that are associated with the performance indicator based on the rank associated with each of the plurality of master data measures.

4. The method of claim 1, further comprising:
for each time period of the plurality of times periods, determining a value of the performance indictor; and
preparing the determined value for display to the user through the graphical user interface.

5. The method of claim 4, wherein the value of the performance indicator is based on the value of the one or more data measures.

6. The method of claim 1, wherein the performance indicator is directly correlated to the one or more master data measures.

7. The method of claim 1, wherein the difference between the values of the one or more master data measures is greater than a threshold.

8. The method of claim 1, further comprising receiving, from the user, a request for analysis of the set of data, wherein identifying the performance indicator further comprises identifying the performance indicator based on the request.

9. A computer storage medium encoded with a computer program, the program comprising instructions that when executed by one or more computers cause the one or more computers to perform operations comprising:
identifying a performance indicator associated with a set of data, the performance indicator representing a statistical metric associated with the set of data;
identifying one or more master data measures associated with the performance indicator from a plurality of master data measures, the performance indicator based on the one the master data measures;
for each time period of a plurality of times periods, determining a value of the one or more master data measures;
for each master data measure, determining a difference between the values of the master data measure associated with two time periods of the plurality of time period; and
preparing the determined difference for display to a user through a graphical user interface.

10. The computer storage medium of claim 9, the operations further comprising:
defining the plurality of master data measures based on an additional set of data; and
associating one or more of the plurality of master data measures with one or more performance indicators of a plurality of performance indicators.

11. The computer storage medium of claim 10, the operations further comprising, for each performance indictor of the plurality of performance indicators:
identifying a rank associated with each of the master data measures; and
ranking the plurality of master data measures that are associated with the performance indicator based on the rank associated with each of the plurality of master data measures.

12. The computer storage medium of claim 9, the operations further comprising:
for each time period of the plurality of times periods, determining a value of the performance indictor; and
preparing the determined value for display to the user through the graphical user interface.

13. The computer storage medium of claim 12, wherein the value of the performance indicator is based on the value of the one or more data measures.

14. The computer storage medium of claim 9, wherein the difference between the values of the one or more master data measures is greater than a threshold.

15. A system of one or more computers configured to perform operations comprising:
identifying a performance indicator associated with a set of data, the performance indicator representing a statistical metric associated with the set of data;
identifying one or more master data measures associated with the performance indicator from a plurality of master data measures, the performance indicator based on the one the master data measures;
for each time period of a plurality of times periods, determining a value of the one or more master data measures;
for each master data measure, determining a difference between the values of the master data measure associated with two time periods of the plurality of time period; and
preparing the determined difference for display to a user through a graphical user interface.

16. The system of claim 15, the operations further comprising:
defining the plurality of master data measures based on an additional set of data; and
associating one or more of the plurality of master data measures with one or more performance indicators of a plurality of performance indicators.

17. The system of claim 16, the operations further comprising, for each performance indictor of the plurality of performance indicators:
identifying a rank associated with each of the master data measures; and
ranking the plurality of master data measures that are associated with the performance indicator based on the rank associated with each of the plurality of master data measures.

18. The system of claim 15, the operations further comprising:
for each time period of the plurality of times periods, determining a value of the performance indictor; and
preparing the determined value for display to the user through the graphical user interface.

19. The system of claim 18, wherein the value of the performance indicator is based on the value of the one or more data measures.

20. The system of claim 15, wherein the difference between the values of the one or more master data measures is greater than a threshold.
